(19) United States
(12) Patent Application Publication
(10) Pub. No.: US 2007/0247165 A1
(43) Pub. Date: Oct. 25, 2007

(54) Wafer backside particle detection for track tools

(75) Inventor: Harald Herchen, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 11/411,422

(22) Filed: Apr. 25, 2006

(51) Int. Cl. G01N 27/00; G01N 27/60

(52) U.S. Cl. 324/455; 324/71.1

(57) ABSTRACT

A particle detection apparatus includes a substrate support adapted to support a substrate. The substrate support includes a number of proximity pins extending a predetermined distance from a surface of the substrate support and a number of probe electrodes coupled to the surface of the substrate support. The particle detection apparatus also includes electrical circuitry electrically coupled to the substrate support and adapted to generate an electric field at a backside of the substrate in contact with the plurality of proximity pins. The particle detection apparatus further includes detection circuitry electrically coupled to the plurality of probe electrodes and a processor adapted to process electrical signals associated with the detection circuitry.

### BACKGROUND OF THE INVENTION

The present invention relates generally to the field of substrate processing equipment. More particularly, the present invention relates to the detection of backside particles on a semiconductor substrate. Merely by way of example, the method and apparatus of the present invention are used to detect particles in a photolithography coating system using a corona discharge technique. The method and apparatus can be applied to other processes for semiconductor substrates, for example those used in the formation of integrated circuits.

Modem integrated circuits contain millions of individual elements that are formed by patterning the materials, such as silicon, metal and/or dielectric layers, which make up the integrated circuit, to sizes that are small fractions of a micrometer. The technique used throughout the industry for forming such patterns is photolithography. A typical photolithography process sequence generally includes depositing one or more uniform photoresist (resist) layers on the surface of a substrate, drying and curing the deposited layers, patterning the substrate by exposing the photoresist layer to electromagnetic radiation that is suitable for modifying the exposed layer, and then developing the patterned photoresist layer.

It is common in the semiconductor industry for many of the steps associated with the photolithography process to be performed in a multi-chamber processing system (e.g., a cluster tool) that has the capability to sequentially process semiconductor wafers in a controlled manner. One example of a cluster tool that is used to deposit (i.e., coat) and develop a photoresist material is commonly referred to as a track lithography tool.

Track lithography tools typically include a mainframe that houses multiple chambers (which are sometimes referred to herein as stations) dedicated to performing the various tasks associated with pre- and post-lithography processing. There are typically both wet and dry processing chambers within track lithography tools. Wet chambers include coat and/or develop bowls, while dry chambers include thermal control units that house bake and/or chill plates. Track lithography tools also frequently include one or more pod/cassette mounting devices, such as an industry standard FOUP (front opening unified pod), to receive substrates from and return substrates to the clean room, multiple substrate transfer robots to transfer substrates between the various chambers/stations of the track tool, and an interface that allows the tool to be operatively coupled to a lithography exposure tool in order to transfer substrates into the exposure tool and receive substrates from the exposure tool after the substrates are processed within the exposure tool.

Over the years there has been a strong push within the semiconductor industry to shrink the size of semiconductor devices. As device size has decreased, the importance of reducing the presence of contaminant particles has increased since these particles may lead to the formation of defects during the semiconductor fabrication process. In order to maintain high manufacturing yield and low costs, the detection and removal of contaminant particles is desirable. Moreover, as lithographic depth of focus associated with manufacturing circuits with smaller feature sizes becomes more constrained, control of backside particles is needed to minimize wafer non-planarity during exposure.

Some particle detection systems use optical detection methods that, for example, use a small laser spot that scans the backside of the substrate or wafer to detect light scattered off particles. However, many of these particle detection systems use special techniques to minimize background scatter, resulting in high levels of system complexity and high cost. Additionally, these particle detection systems do not provide the level of control desirable for current and future track lithography tools. Therefore, there is a need in the art for improved methods and apparatus for detecting particles on the backside of a semiconductor substrate in a track lithography tool.

### SUMMARY OF THE INVENTION

According to embodiments of the present invention, techniques generally related to the field of substrate processing equipment are provided. More particularly, the present invention relates to the detection of backside particles on a semiconductor substrate. Merely by way of example, the method and apparatus of the present invention are used to detect particles in a photolithography coating system using a corona discharge technique. The method and apparatus can be applied to other processes for semiconductor substrates, for example those used in the formation of integrated circuits.

According to an embodiment of the present invention, a particle detection apparatus is provided. The particle detection apparatus includes a substrate support adapted to support a substrate and including a number of proximity pins extending a predetermined distance from a surface of the substrate support and a number of probe electrodes coupled to the surface of the substrate support. The particle detection apparatus also includes electrical circuitry electrically coupled to the substrate support and adapted to generate an electric field at a backside of the substrate in contact with the plurality of proximity pins and detection circuitry electrically coupled to the plurality of probe electrodes. The particle detection apparatus further includes a processor adapted to process electrical signals associated with the detection circuitry.

According to another embodiment of the present invention, a method of detecting one or more particles on a backside of a substrate is provided. The method includes providing a substrate support adapted to support the substrate a predetermined distance above a surface of the substrate support and providing an electrical signal to a plurality of probe electrodes coupled to the substrate support, thereby applying an electric field to the backside of the substrate. The method also includes detecting a corona discharge from the one or more particles on the backside of the substrate and processing the detected corona discharge to detect the one or more particles.

According to an alternative embodiment of the present invention, a track lithography tool including a particle detection apparatus is provided. The particle detection apparatus includes a substrate support adapted to support a substrate and including a number of proximity pins extending a predetermined distance from a surface of the substrate support and a number of probe electrodes coupled to the surface of the substrate support. The particle detection apparatus also includes electrical circuitry electrically coupled to the substrate support and adapted to generate an electric field at a backside of the substrate in contact with the plurality of proximity pins. The particle detection apparatus further includes detection circuitry electrically coupled to the plurality of probe electrodes and a processor adapted to process electrical signals associated with the detection circuitry.

Many benefits are achieved by way of the present invention over conventional techniques. For example, an embodiment provides a method of detecting backside particles that is faster than conventional optical techniques. A particular embodiment of the present invention reduces the area of the backside of the wafer that is examined for particles, improving detection speed. Furthermore, leveraging the clean processing conditions characteristic of semiconductor processing operations, embodiments of the present invention utilize an automatic calibration process that is independent of many wafer-to-wafer variations. Depending upon the embodiment, one or more of these benefits, as well as other benefits, may be achieved. These and other benefits will be described in more detail throughout the present specification and more particularly below in conjunction with the following drawings.

### BRIEF DESCRIPTION OF THE DRAWINGS

FIG. 1 is a simplified plan view of an embodiment of a track lithography tool according to an embodiment of the present invention;

FIG. 2 is a simplified cross-sectional view of a portion of a particle detection apparatus according to an embodiment of the present invention; and

FIG. 3 is a simplified schematic diagram illustrating a top-view of a substrate support according to an embodiment of the present invention.

### DETAILED DESCRIPTION OF SPECIFIC EMBODIMENTS

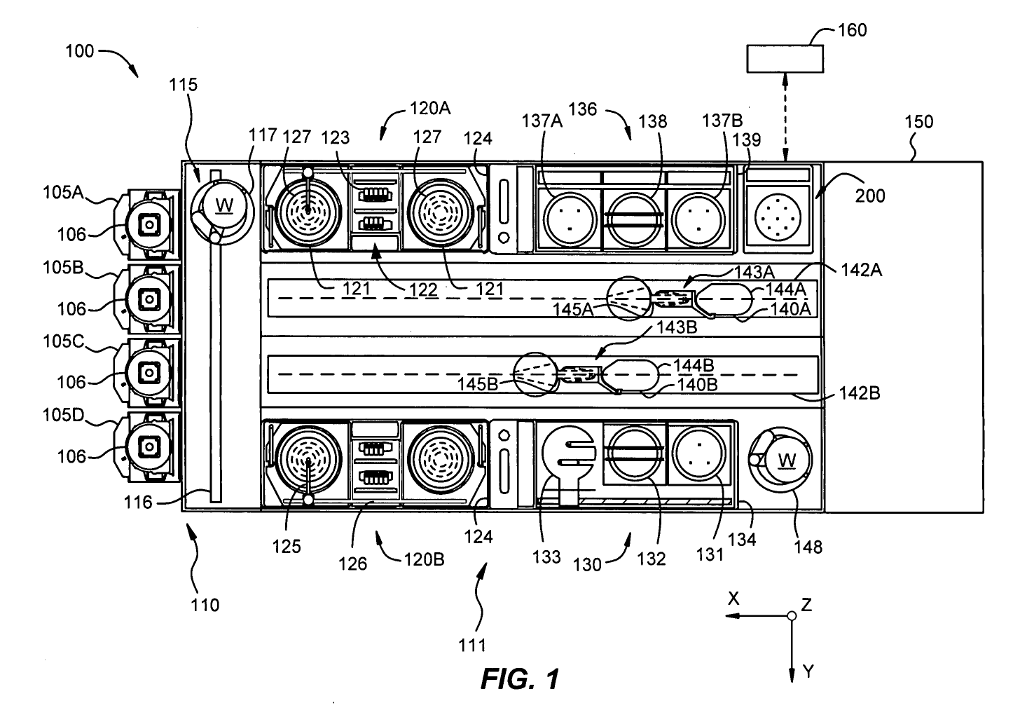

FIG. 1 is a plan view of an embodiment of a track lithography tool 100 in which the embodiments of the present invention may be used. As illustrated in FIG. 1, track lithography tool 100 contains a front end module 110 (sometimes referred to as a factory interface or FI) and a process module 111. In other embodiments, the track lithography tool 100 includes a rear module (not shown), which is sometimes referred to as a scanner interface. Front end module 110 generally contains one or more pod assemblies or FOUPS (e.g., items 105A-D) and a front end robot assembly 115 including a horizontal motion assembly 116 and a front end robot 117. The front end module 110 may also include front end processing racks (not shown). The one or more pod assemblies 105A-D are generally adapted to accept one or more cassettes 106 that may contain one or more substrates or wafers, “W,” that are to be processed in track lithography tool 100. The front end module 110 may also contain one or more pass-through positions (not shown) to link the front end module 110 and the process module 111.

Process module 111 generally contains a number of processing racks 120A, 120B, 130, and 136. As illustrated in FIG. 1, processing racks 120A and 120B each include a coater/developer module with shared dispense 124. A coater/developer module with shared dispense 124 includes two coat bowls 121 positioned on opposing sides of a shared dispense bank 122, which contains a number of nozzles 123 providing processing fluids (e.g., bottom anti-reflection coating (BARC) liquid, resist, developer, and the like) to a wafer mounted on a substrate support 127 located in the coat bowl 121. In the embodiment illustrated in FIG. 1, a dispense arm 125 sliding along a track 126 is able to pick up a nozzle 123 from the shared dispense bank 122 and position the selected nozzle over the wafer for dispense operations. Of course, coat bowls with dedicated dispense banks are provided in alternative embodiments.

Processing rack 130 includes an integrated thermal unit 134 including a bake plate 131, a chill plate 132, and a shuttle 133. The bake plate 131 and the chill plate 132 are utilized in heat treatment operations including post exposure bake (PEB), post-resist bake, and the like. In some embodiments, the shuttle 133, which moves wafers in the x-direction between the bake plate 131 and the chill plate 132, is chilled to provide for initial cooling of a wafer after removal from the bake plate 131 and prior to placement on the chill plate 132. Moreover, in other embodiments, the shuttle 133 is adapted to move in the z-direction, enabling the use of bake and chill plates at different z-heights. Processing rack 136 includes an integrated bake and chill unit 139, with two bake plates 137A and 137B served by a single chill plate 138.

One or more robot assemblies (robots) 140 are adapted to access the front-end module 110, the various processing modules or chambers retained in the processing racks 120A, 120B, 130, and 136, and the scanner 150. By transferring substrates between these various components, a desired processing sequence can be performed on the substrates. The two robots 140 illustrated in FIG. 1 are configured in a parallel processing configuration and travel in the x-direction along horizontal motion assembly 142. Utilizing a mast structure (not shown), the robots 140 are also adapted to move in a vertical (z-direction) and horizontal directions, i.e., transfer direction (x-direction) and a direction orthogonal to the transfer direction (y-direction). Utilizing one or more of these three directional motion capabilities, robots 140 are able to place wafers in and transfer wafers between the various processing chambers retained in the processing racks that are aligned along the transfer direction.

Referring to FIG. 1, the first robot assembly 140A and the second robot assembly 140B are adapted to transfer substrates to the various processing chambers contained in the processing racks 120A, 120B, 130, and 136. In one embodiment, to perform the process of transferring substrates in the track lithography tool 100, robot assembly 140A and robot assembly 140B are similarly configured and include at least one horizontal motion assembly 142, a vertical motion assembly 144, and a robot hardware assembly 143 supporting a robot blade 145. Robot assemblies 140 are in communication with a system controller 160. In the embodiment illustrated in FIG. 1, a rear robot assembly 148 is also provided.

The scanner 150, which may be purchased from Canon USA, Inc. of San Jose, Calif., Nikon Precision Inc. of Belmont, Calif., or ASML US, Inc. of Tempe Ariz., is a lithographic projection apparatus used, for example, in the manufacture of integrated circuits (ICs). The scanner 150 exposes a photosensitive material (resist), deposited on the substrate in the cluster tool, to some form of electromagnetic radiation to generate a circuit pattern corresponding to an individual layer of the integrated circuit (IC) device to be formed on the substrate surface.

Each of the processing racks 120A, 120B, 130, and 136 contain multiple processing modules in a vertically stacked arrangement. That is, each of the processing racks may contain multiple stacked coater/developer modules with shared dispense 124, multiple stacked integrated thermal units 134, multiple stacked integrated bake and chill units 139, or other modules that are adapted to perform the various processing steps required of a track photolithography tool. As examples, coater/developer modules with shared dispense 124 may be used to deposit a bottom antireflective coating (BARC) and/or deposit and/or develop photoresist layers. Integrated thermal units 134 and integrated bake and chill units 139 may perform bake and chill operations associated with hardening BARC and/or photoresist layers after application or exposure.

In one embodiment, a system controller 160 is used to control all of the components and processes performed in the cluster tool 100. The controller 160 is generally adapted to communicate with the scanner 150, monitor and control aspects of the processes performed in the cluster tool 100, and is adapted to control all aspects of the complete substrate processing sequence. The controller 140, which is typically a microprocessor-based controller, is configured to receive inputs from a user and/or various sensors in one of the processing chambers and appropriately control the processing chamber components in accordance with the various inputs and software instructions retained in the controller's memory. The controller 140 generally contains memory and a CPU (not shown) which are utilized by the controller to retain various programs, process the programs, and execute the programs when necessary. The memory (not shown) is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits (not shown) are also connected to the CPU for supporting the processor in a conventional manner. The support circuits may include cache, power supplies, clock circuits, input/output circuitry, subsystems, and the like all well known in the art. A program (or computer instructions) readable by the controller 140 determines which tasks are performable in the processing chamber(s). Preferably, the program is software readable by the controller 160 and includes instructions to monitor and control the process based on defined rules and input data.

It is to be understood that embodiments of the invention are not limited to use with a track lithography tool such as that depicted in FIG. 1. Instead, embodiments of the invention may be used in any track lithography tool including the many different tool configurations described in U.S. patent application Ser. No. 11/315,984, entitled “Cartesian Robot Cluster Tool Architecture” filed on Dec. 22, 2005, which is hereby incorporated by reference for all purposes and including configurations not described in the above referenced application.

Referring to FIG. 1, a particle detection apparatus 200 is provided as a module in the track lithography tool 100. The particle detection apparatus 200 is serviced by one or both of the robot assemblies 140 and is utilized, as described more fully throughout the present specification, to detect particles present on the backside of a wafer or substrate. The use of the particle detection apparatus may occur before or after several of the wafer processes performed within the track lithography tool 100. These wafer processing include coat, develop, bake, chill, exposure, and the like. In a particular embodiment, the substrate is scanned for particles prior to processing by the scanner. In alternative embodiments, the particle detection apparatus 200 is located external to the track lithography tool 100 in a separate stand-alone test module. One of ordinary skill in the art would recognize many variations, modifications, and alternatives.

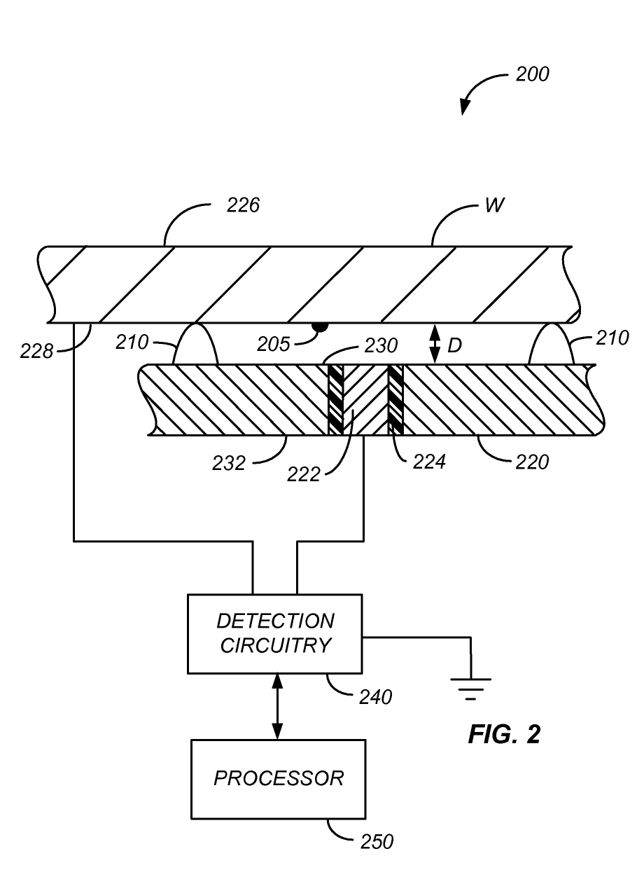

FIG. 2 is a simplified cross-sectional view of a portion of a particle detection apparatus 200 according to an embodiment of the present invention. Referring to FIG. 2, a wafer W is supported on a number of proximity pins 210. A particle 205 is present on the backside of the wafer W. The particle detection apparatus 200 utilizes a substrate support 220 including a number of probe electrodes 222 that are electrically connected to detector circuitry (not shown). In the embodiment illustrated in FIG. 2, the probe electrodes 222 are electrically isolated from the substrate support 220 by annular insulators 224. The probe electrodes can be made using refractory metals not significantly degraded by discharge, for example, Hf, TiN, and the like.

According to embodiments of the present invention, current flow or voltage drops accompanying a corona discharge are utilized to detect the presence of a particle on the backside of a substrate. A corona discharge is produced when a sharp point at a positive potential (a charged conductor) is characterized by a high surface charge density. For a charged conductor with sharp points, the value of the electric field in the air near the points can be high. At a sufficiently high value of the electric field, ions present in the air will be accelerated toward the conductor, and by collision with air molecules, will produce additional ions. Thus the air, or other gaseous environment such as nitrogen in the vicinity of the charged conductor, is made more conducting and a corona discharge will result, thereby discharging the stored charge on the conductor to ground.

For backside particle detection applications, particles present on the backside of the substrate provide the sharp points at which the corona discharge is produced. Thus, referring to FIG. 2, particle 205 will provide the feature at which corona discharge results, enabling the presence of the particle to be detected. In embodiments of the present invention, the occurrence of a corona discharge on the backside of the wafer will be utilized in detecting backside particles without damage to the front of the wafer, where integrated circuits are present. Preferably any damage caused to the backside of the wafer as a result of this corona discharge will be below levels that impact the reliability of the integrated circuits formed on the wafer.

The gap D between the wafer W and the substrate support 220 is selected to provide a small distance from any particles on the backside of the wafer to the probe electrodes 222 in the support substrate 220. In a particular embodiment, the gap D is between about 0.5 μm and about 30 μm. The value of the gap is determined by the height of the proximity pins 210 and any extension of the probe electrodes 222 above or below the surface of the substrate support 220 facing the wafer W. As illustrated in FIG. 2, the probe electrodes 222 are flush with the upper surface of the substrate support 220, so that the gap D between the wafer W and the probe electrodes 222 is determined by the height of the proximity pins 210. In other embodiments, an air bearing is utilized to support the substrate a predetermined distance above the surface of the substrate support.

As discussed above, the electric field in the vicinity of particle 205 is increased by the presence of the particle 205, leading to a corona discharge from the particle 205 to the adjacent probe electrode 222. The corona discharge will occur at a lower potential than a corresponding potential associated with the absence of a particle. In an embodiment, the discharge is detected by comparing the potential on each probe electrode while applying the same voltage through a high impedance circuit to each probe electrode. Generally, the voltage potential between the probe electrodes and the counter electrodes is on the order of tens of volts, depending on the gap D, among other factors.

Portions of the wafer backside on which particles are present will experience a corona discharge as a threshold voltage is reached, allowing a small amount of current to flow. An area with a particle will produce a current that is slightly different from particle-free areas. The current flow changes the potential on the probe electrode, which can be picked up by a galvanometer or equivalent differential charge detector. The current flow as a result of the corona discharge is a function of the number of electrons transferred from the particle to the particular probe electrode adjacent the particle. The detection circuitry 240 connected to the probe electrodes 222 utilizes a limiting resistor/capacitor combination to ensure sufficient current flow for detection, while also ensuring that the current flow is not sufficiently high to cause unacceptable levels of wafer backside damage. A processor 250 utilizes electrical signals from the detection circuitry to detect the presence of a corona discharge and associate such a discharge with the presence of a particle.

In embodiments of the present invention, the same electric field is developed at probe electrode locations where there are no particles, allowing the detection circuitry to perform a comparison with the current in locations where the higher electric field due to the presence of a particle results in a corona discharge. This comparison enables the detection circuitry and processing circuitry to determine the presence of one or more particles.

Thus, other embodiments of the present invention will detect the flow of between one and 30 electrons per particle using a micro-channel plate photomultiplier tube. Depending on the type of particle and the applied voltage bias, the current flow per particle will vary, providing more than 30 electrons in some applications. One of ordinary skill in the art would recognize many variations, modifications, and alternatives.

The presence of the particle is then localized to the probe electrode with the relatively lower potential. The minimum particle size detected will be determined by the gap size, the variation in the gap from location to location, and by the sensitivity of the differential charge detector, among other factors. Wafer cleaning and particle removal techniques are utilized to remove the particles detected using embodiments of the present invention.

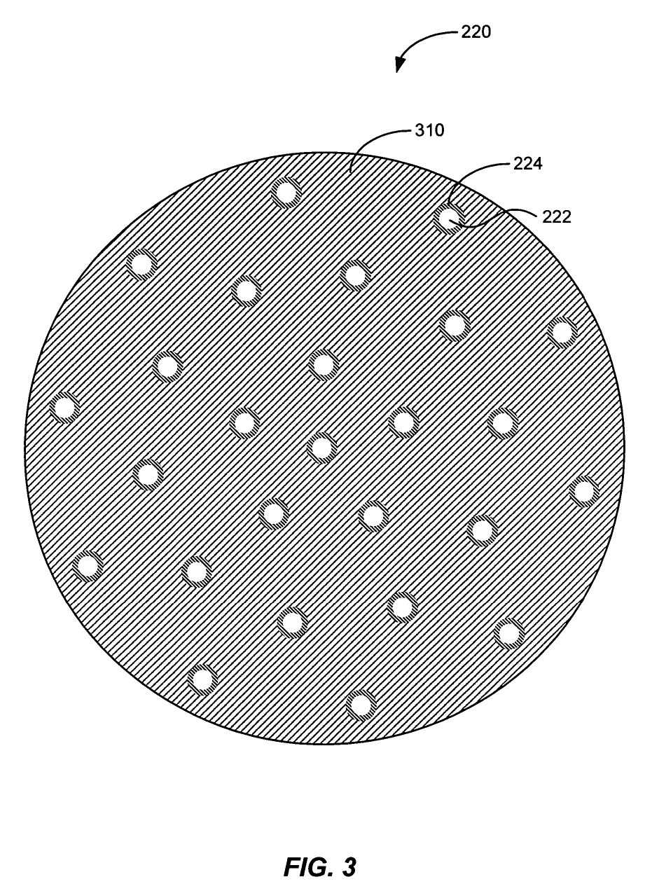

FIG. 3 is a simplified schematic diagram illustrating a top view of a substrate support according to an embodiment of the present invention. The substrate support 220 includes a number of probe electrodes 222 that are distributed across the surface of the substrate support 220. The proximity pins 210 illustrated in FIG. 2 are omitted in FIG. 3 for purposes of clarity. The probe electrodes 222 are each surrounded by an annular insulator 224 that electrically isolates the probe electrodes 222 from a counter electrode 310 formed on the surface of the substrate support. As illustrated in FIG. 3, the counter electrode 310 covers the majority of the surface of the substrate support, although this is not required by the present invention.

Referring to FIG. 3, portions of the substrate support serve as a counter electrode 310, which is close, but not in contact with the substrate W, which is supported, for example, on proximity pins. The counter electrode 310, which has a larger area than the probe electrodes, ensures that the wafer potential remains near ground during the measurement. The counter electrode is fabricated using conductive ceramics, metals, or other suitable materials. The counter electrode is electrically energized to the opposite potential of the probe electrodes and the area of the counter electrode is selected to match capacitance values and thereby keep the wafer at or near ground potential. In alternative embodiments, multiple counter electrodes are utilized. The one or more counter electrodes are placed at locations for which particle measurements are not made or near the edge of the wafer.

According to embodiments of the present invention, the probe electrodes 222 are spatially arranged in a predetermined pattern. In a specific embodiment, the spatial arrangement of the probe electrodes 222 corresponds to the location where the backside of the wafer is in contact with the exposure chuck during exposure in the scanner. Thus areas of interest on the backside of the substrate (correlated with the location of wafer supports on the scanner chuck) are probed in parallel. Generally, the lateral dimensions of the probe electrodes are slightly larger than the dimensions of the vacuum chuck pads utilized in the scanner. Thus, particles generated in the scanner by contact between the backside of the wafer and the scanner vacuum chuck pads will be within a column extending from the substrate support in a direction normal to the surface of the substrate support. By locally detecting particles at locations expected to generate particles, embodiments of the present invention simplify the detection process compared to conventional processes.

The detection process provided by embodiments of the present invention contrasts with optical detection processes in which the full backside of the substrate is scanned, either by rotating the optics, rotating the substrate, translating the substrate, or some combination thereof. In these optical scanning techniques, the detection process is slower than that provided by embodiments of the present invention. Moreover, such optical techniques do not limit their search to the portions of the total wafer backside most likely to have particles. According to embodiments of the present invention, the probe electrodes 222 are placed near locations where the scanner exposure chuck will contact the backside of the substrate, enabling concurrent testing of selected portions of the backside of the wafer for particles. Reducing the testing area to areas in the vicinity of locations where particles are expected, the area over which particles are scanned is reduced significantly and may be reduced by a factor of up to 100 or more.

Embodiments of the present invention utilize an automatic calibration process in which the voltage breakdown measured for the majority of locations, which are assumed to be particle free, is compared. In general, the wafer backside can be covered with various coatings and is characterized by varying surface roughness. Thus, for a particular particle-free area of the backside of the substrate, there may be some variation in the voltage needed to cause a corona discharge. This will be applicable, even in the absence of particles. Merely by way of example, regions of the substrate characterized by thicker oxide layers will generally produce lower corona discharge currents than regions of the substrate characterized by thinner oxide layers.

Due to the clean nature of semiconductor processing operations, the statistical likelihood of multiple locations having particles is exceptionally low. Probing many areas of the substrate concurrently using multiple sensors, each location can be compared. The voltage at which a corona discharge is induced or current flow will be measured for each probe electrode. Then, the most common voltage needed to induce a corona discharge will be interpreted as the baseline voltage associated with the absence of particles. In locations for which a lower voltage (or higher current pulse) is measured, the presence of a particle is indicated. Thus, the calibration of the particle detection system for different wafers with various coatings and surface roughness values is automatically calibrated.

The examples and embodiments described herein are for illustrative purposes only. Various modifications or changes in light thereof will be suggested to persons skilled in the art and are to be included within the spirit and purview of this application and scope of the appended claims. It is not intended that the invention be limited, except as indicated by the appended claims.

1. A particle detection apparatus comprising:
a substrate support adapted to support a substrate having a process surface and backside, the substrate support having a support surface and a base surface opposing the support surface and including:
a plurality of proximity pins extending a predetermined distance from the support surface of the substrate support, wherein the plurality of proximity pins are adapted to make contact with the backside of the substrate, and
a plurality of probe electrodes disposed in the substrate support and adapted to receive a corona discharge from a particle disposed on the backside of the substrate to one of the plurality of probe electrodes through a region between the plurality of probe electrodes and the backside of the substrate, each of the plurality of probe electrodes surrounded by an annular insulator and arranged with substantially equal spacing over the support surface of the substrate support;
electrical circuitry electrically coupled to the substrate support and the plurality of probe electrodes, the electrical circuitry being adapted to generate an electric field in the region between the plurality of probe electrodes and the backside of the substrate, the electrical circuitry including a high impedance circuit adapted to conduct a discharge-inducing electric field voltage to the plurality of probe electrodes;
detection circuitry electrically coupled to the plurality of probe electrodes and adapted to detect a corona discharge, the detection circuitry including a limiting resistor/capacitor combination adapted to monitor and restrict current flow to the plurality of probe electrodes; and
a processor adapted to process electrical signals associated with the detection circuitry.

2. The particle detection apparatus of claim 1 wherein the predetermined distance ranges from about 0.5 μm to about 30 μm.

3. The particle detection apparatus of claim 2 wherein the predetermined distance ranges from about 2 μm to about 5 μm.

4. (canceled)

5. The particle detection apparatus of claim 4 wherein a surface of each of the plurality of probe electrodes is flush with the support surface of the substrate support.

6. The particle detection apparatus of claim 4 wherein the plurality of probe electrodes pass through the substrate support from the base surface to the support surface.

7. The particle detection apparatus of claim 1 wherein the substrate comprises a semiconductor wafer.

8. The particle detection apparatus of claim 1 wherein the processor is adapted to monitor a current flow through the detection circuitry, the current flow being associated with the corona discharge from the particle.

9. The particle detection apparatus of claim 1 wherein the processor is adapted to monitor a voltage drop using the detection circuitry, the voltage drop being associated with the corona discharge from the particle.

10. A method of detecting one or more particles on a backside of a substrate, the method comprising:
providing a substrate support adapted to support the backside of the substrate a predetermined distance above a support surface of the substrate support;
providing an electrical signal to a plurality of probe electrodes disposed in the substrate support through a high impedance circuit, thereby applying an electric field to the backside of the substrate, wherein each of the plurality of probe electrodes is surrounded by an annular insulator and arranged with substantially equal spacing over the support surface of the substrate support, each of the plurality of probe electrodes being adapted to receive a corona discharge from one of the one or more particles on the backside of the substrate to one of the plurality of probe electrodes;
detecting a corona discharge from the one of the or more particles on the backside of the substrate to the one of the plurality of probe electrodes;
passing a corona discharge signal through detection circuitry including a limiting resistor/capacitor combination adapted to monitor and restrict current flow to the plurality of probe electrodes; and
processing the detected corona discharge to detect the one or more particles.

11. The method of claim 10 wherein the substrate support includes a plurality of proximity pins extending a predetermined distance from a surface of the substrate support.

12. The method of claim 11 wherein the predetermined distance ranges from about 0.5 μm to about 30 μm.

13. The method of claim 12 wherein the predetermined distance ranges from about 2 μm to about 5 μm.

14. The method of claim 10 wherein providing an electrical signal is performed using the plurality of probe electrodes.

15. The method of claim 14 wherein a surface of each of the plurality of probe electrodes is flush with the surface of the substrate support.

16. The method of claim 14 wherein the plurality of probe electrodes pass through the substrate support.

17. A track lithography tool including a particle detection apparatus, the particle detection apparatus comprising:
a substrate support adapted to support a backside of a substrate and including:
a plurality of proximity pins extending a predetermined distance from a support surface of the substrate support, and
a plurality of probe electrodes disposed in the substrate support and adapted to receive a corona discharge from a particle disposed on the backside of the substrate to one of the plurality of probe electrodes through a region between the plurality of probe electrodes and the backside of the substrate, each of the plurality of probe electrodes surrounded by an annular insulator and arranged in substantially equal spacing over the support surface of the substrate support;
electrical circuitry electrically coupled to the substrate support and the plurality of probe electrodes, the electrical circuitry being adapted to generate an electric field in a region between each of the plurality of probe electrodes and the backside of the substrate, the electrical circuitry including a high impedance circuit adapted to conduct a discharge-inducing electric field voltage to the plurality of probe electrodes;
detection circuitry electrically coupled to the plurality of probe electrodes and adapted to detect a corona discharge, the detection circuitry including a limiting resistor/capacitor combination adapted to monitor and restrict current flow to the plurality of probe electrodes; and
a processor adapted to process electrical signals associated with the detection circuitry.

18. (canceled)

19. The track lithography tool of claim 17 wherein the processor is adapted to monitor a current flow through the detection circuitry, the current flow being associated with the corona discharge from the particle.

20. The track lithography tool of claim 17 wherein the processor is adapted to monitor a voltage drop using the detection circuitry, the voltage drop being associated with the corona discharge from the particle.
